(19) United States
(12) Patent Application Publication
(10) Pub. No.: US 2013/0325641 A1
(43) Pub. Date: Dec. 5, 2013

(54) METHOD AND SYSTEM FOR MANAGING MULTIPLE ENTITY FOOD VENDOR RECOMMENDATION AND ORDERING SERVICES

(71) Applicant: ToGoOrder.com LLC, Nashville, TN (US)

(72) Inventors: Darby W. Brown, Nashville, TN (US); Paul Root, Spring Hill, TN (US); Dan Simpson, Nashville, TN (US)

(73) Assignee: ToGoOrder.com LLC, Nashville, TN (US)

(21) Appl. No.: 13/905,499

(22) Filed: May 30, 2013

Related U.S. Application Data
(60) Provisional application No. 61/653,082, filed on May 30, 2012.

(51) Int. Cl. G06Q 30/06; G06Q 50/12

(52) U.S. Cl. CPC G06Q 30/0631; G06Q 50/12
USPC 705/15

(57) ABSTRACT

A system, including apparatuses and methods, for managing multiple entity food vendor recommendation and ordering services. The system includes a host server operable for data communication via a communication network. The host server is configured to receive from the communication network input data related to a consumer location, input data related to consumer preferences, input data related to at least one restaurant, and input data related to menu information for the at least one restaurant. The host server is configured, based on at least in part upon the input data applied to at least one recommendation rule, to determine a recommendation of at least one of a restaurant and a menu item, and the host server is configured to transmit the recommendation to the communication network.

This application claims priority under 35 U.S.C. §119(e) to U.S. Provisional Patent Application No. 61/653,082, entitled “A METHOD AND SYSTEM FOR MANAGING MULTIPLE ENTITY RESTAURANT RECOMMENDATION AND ORDERING SERVICES,” filed May 30, 2012, the entire contents of which are incorporated herein by reference.

### FIELD OF THE INVENTION

The present invention relates to a method and system for managing multiple entity food vendor recommendation and ordering services. More particularly, the present invention relates to a method and system for managing the recommending of multiple restaurants (including, but not limited to food trucks, grocery stores, sporting events, and other entities that provide food), recommending multiple dishes at multiple restaurants, and ordering from one or more restaurants.

### BACKGROUND OF THE INVENTION

Consumers have been searching and ordering food and other items online through computers and handheld devices.

Interactive ordering systems exist that utilize computer controlled systems which include a database containing restaurant menu items. These interactive systems permit customers to access a restaurant's menu items locally or remotely to select desired menu items for purchase. Typically, these systems require the customer to select the restaurant serving the customer's geographic region, and do not provide recommendations for various restaurants and menu items.

There is a need in the industry for a system that provides consumers with recommendations of menu items, based at least in part on the consumer's location and preferences, and that provides food vendors the ability to maintain up-to-date menus that are easily accessible to consumers and to take orders based on those menu items. The system and method of the present invention resolves these and other related problems and deficiencies.

### SUMMARY OF THE INVENTION

Briefly described, the present invention comprises a system, including apparatuses and methods, for managing multiple entity food vendor recommendation and ordering services. By managing food vendor recommendation and ordering services through the use of consumer provided information and food vendor provided information, the present invention is able to provide better, more accurate, and up-to-date recommendations of current offerings. Further, the system allows food vendors to accurately receive orders, monitor inventory, and provide up-to-date menu items to multiple consumers.

In one embodiment of the present invention, the method for managing multiple entity food vendor recommendation and ordering services comprises receiving consumer location data, consumer preference data, restaurant data, and menu data from a communication network, and receiving recommendation rules from a database. The method further comprises determining recommendation data based on the recommendation rules, the consumer location data, the consumer preference data, the restaurant data, and the menu data, and transmitting the recommendation data to the communication network.

In another embodiment of the present invention, the system for managing multiple entity food vendor recommendation and ordering services comprises a host server operable for data communication via a communication network. The host server is configured to receive from the communication network input data related to a consumer location, input data related to consumer preferences, input data related to at least one restaurant, and input data related to menu information for the at least one restaurant. Additionally, the host server is configured, based on at least in part upon the input data applied to at least one recommendation rule, to determine a recommendation of at least one of a restaurant and a menu item, and to transmit the recommendation to the communication network.

Other advantages of the present invention will become apparent upon reading and understanding the present specification when taken in conjunction with the appended drawings.

### BRIEF DESCRIPTION OF THE DRAWINGS

FIG. 1 is a block diagram representation of a method and system for managing multiple entity restaurant recommendation and ordering services of the preferred embodiment of the present invention.

FIG. 2 is a block diagram representation of a computer software environment of the system for managing multiple entity restaurant recommendation and ordering services of FIG. 1.

FIGS. 3A and 3B are a flowchart representation of an overall system method of the system of FIG. 1.

### DETAILED DESCRIPTION OF THE INVENTION

Disclosed are an exemplary system and method for managing multiple entity food vendor recommendation and ordering services using information related to many distinct food vendors, their offerings and menu items, customer orders for such offerings and menu items through a plurality of platforms and applications, and customer preferences related to type of food vendors, type of cuisines, locations, ingredients, and nutritional aspects. The system is not limited to food vendors with a fix location, such as a restaurant, but also includes food trucks, grocery stores, sporting events, and other entities that provide food.

The present invention also relates to a system that facilitates accurate and timely reporting of merchants, not only food vendors, order fulfillment and performance. The system is designed with the goal of making merchants' fulfillment and management of online-based orders from multiple sources (including the individual merchant's own website and internal point-of-sale platform, and third-party centralized ordering platforms, including without limitation, the system's customer user interface) easier, quicker, and more efficient overall as a function of day-to-day operations of the merchant restaurant and to provide the merchant with a centralized management and analytical tool to better assess revenues from online-based orders regardless of point of origination and collect customer data in relation to such online orders. The system also includes analytical tools to track order fulfillment performance and other reporting tools.

In one aspect of the present invention, the system collects, tracks, displays, and disseminates real-time merchant information that is stored and updated in the central database, including, e.g., wait times, current offerings, daily specials and current pricing. The central processor uses this information to provide more accurate and comprehensive customer recommendations and/or presenting options as part of the ordering process.

In another aspect of the present invention, the system applies several rules to create a profile of information relating to specific menu items, including nutritional data (defined below), ingredients, pricing and cuisine type for each menu item (collectively, the “menu data”) for purposes of generating ranked search results on the system in reference to the Customer Preference Data for an individual customer. In this regard, the system associates nutritional data for selected merchant restaurant menu items according to a plurality of rules that result in a nutritional score of such particular merchant restaurant menu item (the “Nutritional Data”), which are included among the system's rules.

In yet another aspect, the system also collects, analyzes and tracks customer information regarding customer-provided preferences as well as preferences based on order history to generate customized rankings of restaurants and specific menu items based on both customer-provided data and data generated by the customer's previous orders through the system. Customers may access these ratings.

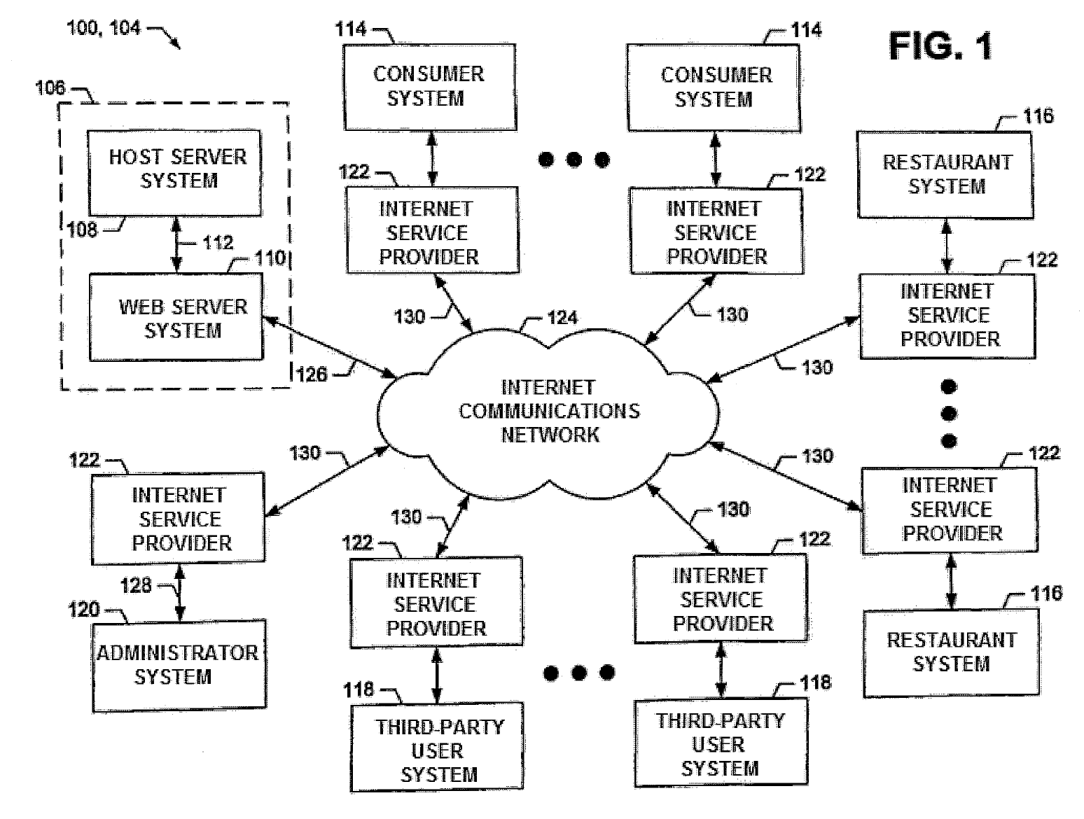

Referring now to the drawings in which like numerals represent similar elements or steps throughout the views, the system 100 for recommending food vendors (also referred to as restaurants) and taking orders of menu items from a consumer of the preferred embodiment of the present invention enables consumers to conduct commerce related to the purchasing of restaurant menu items through electronic data exchange. The system 100 comprises, according to the preferred embodiment, an application service provider system having a computer hardware and data communication environment 102 and a computer software environment 104. FIG. 1 displays a block diagram representation of the computer hardware and data communication environment 102 which comprises a host server system 106 including an applications server computer system 108 (also sometimes referred to herein as “applications server 108”) and a web server computer system 110 which are communicatively connected, via data communication link 112, for bi-directional data communication therebetween. The computer hardware and data communication environment 102 further comprises a plurality of consumer client systems 114 (also sometimes referred to herein as “consumer systems 114”), a plurality of restaurant client systems 116 (also sometimes referred to herein as “restaurant systems 116”), a plurality of third-party client systems 118 (also sometimes referred to herein as “third-party systems 118”), and an administrator client system 120, a plurality of Internet service providers 122, and the Internet communication network 124.

The applications server computer system 108 hosts a plurality of software applications and modules thereof having a plurality of software instructions which, when executed by the applications server computer system 108, cause the applications server computer system 108 to provide consumers and restaurants with the various capabilities and functionality as described herein. The web server computer system 110 is connected to the Internet communication network 124 through data communication link 126 and provides bi-directional data communication exchange capabilities between the applications server computer system 108 and the consumer systems 114, restaurant systems 116, and third-party systems 118, known as “web hosting.” The web server computer system 110 also provides electronic mail (“e-mail”) services for the applications server computer system 108.

Preferably, the applications server computer system 108 and the web server computer system 110 include server computer systems appropriately configured from a hardware and software (including, without limitation, database management, data communications, web hosting, and e-mail hosting software) perspective to provide the capabilities and functionality described herein. Exemplary server computer systems may include: one or more processing units for executing software program instructions; various forms of memory (including, for example and not limitation, random access memory, read-only memory, and flash memory) for storing data and software program instructions; various forms of non-volatile program and data storage devices (including, but not limited to, magnetic disk drives, solid state disk drives or memory, optical disk drives, magneto-optical drives, CD ROM drives, and DVD drives) for storing databases and database management software, web hosting software, email hosting software, data communication software, operating system software, software application programs and modules, configuration data, and other forms of data; various high and low speed data communication interfaces (including, for example and not limitation, local area network interfaces, wide area network interfaces, serial interfaces, and parallel interfaces); at least one display interface and video monitor; user input devices such as a keyboard and/or mouse; and, one or more buses to enable appropriate data communication between the foregoing components. The general operation of applications server computer systems and web server computer systems in an application service provider (“ASP”) model for providing data processing and communication services is well known in the art and, therefore, it is not necessary to include herein a detailed discussion of their operation according to an ASP model. Also preferably, a data communication link 126 acceptable according to the preferred embodiment includes, but is not limited to, T1 links, satellite links, and other present and future forms of, generally, high-speed, multi-channel, dedicated, cabled and non-cabled bi-directional data communication links.

The consumer systems 114, restaurant systems 116, third-party systems 118, and administrator systems 120 are possessed and operated, respectively, by consumers, restaurants managers, third-party users, and system administrators and connect to the Internet communication network 124 through Internet service providers 122 and bi-directional data communication links 128, 130. Preferably, data communication links 128 include, but are not limited to, public switched telephone links, DSL links, broadband cable links, cellular links, satellite links, and other forms of bi-directional cabled and non-cabled, dedicated and non-dedicated data communication links available now or in the future. Also preferably, data communication links 130 include, without limitation, T1 links, satellite links, and other present and future forms of, generally, high-speed, multi-channel, dedicated, cabled and non-cabled bi-directional data communication links. The respective Internet service providers 122 provide data communication interfaces between the various consumer systems 114, restaurant systems 116, third-party systems 118, and administrator systems 120 and the Internet communication network 124, and also provide email services for the consumer systems 114, restaurant systems 116, third-party systems 118, and administrator systems 120. When connected, as desired, to the host server system 106 via data communication links 126, 128, 130, Internet service providers 122, and the Internet communication network 124, the consumer systems 114, restaurant systems 116, third-party systems 118, and administrator systems 120 are operable to bi-directionally exchange data and emails, as clients, with the applications and web server computer systems 108, 110.

The consumer systems 114, restaurant systems 116, third-party systems 118, and administrator systems 120 include, generally, desktop computer systems, portable computer systems and/or cellular/mobile devices equipped with Internet browser software which is operable to receive and display web pages and other data received from the applications server computer system 108 and to receive and communicate user inputs from a keyboard or mouse to the applications server computer system 108. The consumer systems 114, restaurant systems 116, third-party systems 118, and administrator systems 120 further include data and client email communication software. Preferably, the consumer systems 114, restaurant systems 116, third-party systems 118, and administrator systems 120 comprise: one or more processing units for executing software program instructions; various forms of memory (including, for example and not limitation, random access memory, read-only memory, and flash memory) for storing data and software program instructions; various forms of non-volatile program and data storage devices (including, but not limited to, magnetic disk drives, solid state disk drives or memory, optical disk drives, magneto-optical drives, CD ROM drives, and DVD drives) for storing operating system software, application programs, Internet browser software, data communication software, client email communication software, configuration data, and other forms of data; various high and/or low speed data communication interfaces (including, for example and not limitation, DSL interfaces, broadband cable interfaces, cellular interfaces, satellite interfaces, local area network interfaces, serial interfaces, and parallel interfaces); at least one display interface and video monitor; user input devices such as a keyboard and/or mouse; and, one or more buses to enable appropriate data communication between the foregoing components.

It should be understood that the scope of the present invention includes consumer systems, restaurant systems, third-party systems, and administrator systems which are Internet-enabled, but which do not comprise desktop or portable computer systems. It should be further understood that the scope of the present invention includes communication networks other than the Internet.

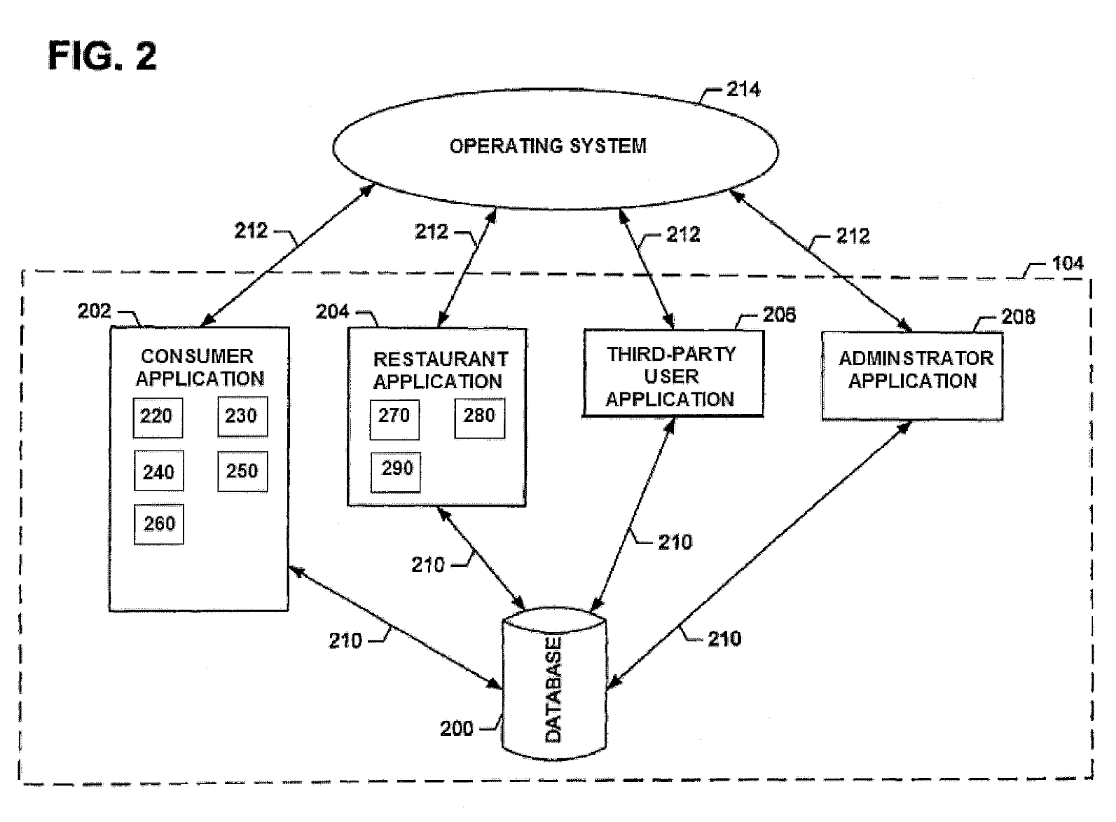

FIG. 2 displays a block diagram representation of the computer software environment 104 of the system 100 for recommending restaurants and taking orders of menu items from a consumer in accordance with the preferred embodiment of the present invention. The computer software environment 104 comprises a database 200 (i.e., managed by back-end database management software which is not shown) for storing the data received and processed by the system 100 and a plurality of computer software application programs (i.e., including computer software instructions) which each reside on a media of a data storage device of the applications server computer system 108. Each of the computer software application programs includes a plurality of software instructions which when executed, during operation, by the one or more processing units of the applications server computer system 108 provide the capabilities, functionality, and features described herein. The computer software application programs include a consumer application 202, a restaurant application 204, a third-party application 206, and an administrator application 208 which provide the system's capabilities, functionality, and features, respectively, to consumers, restaurant managers, third-party users, and system administrators using the system 100 via the Internet browsers of respective consumer systems 114, restaurant systems 116, third-party systems 118, and administrator systems 120 communicatively connected to the host server system 102.

Database 200 resides on a media of a data storage device of the applications server computer system 108 and comprises a central repository for data of the system 100. Preferably, database 200 includes a relational database having a plurality of related and unrelated data tables which store the system's data. Also preferably, the database management software includes a back-end, relational database management program residing on a data storage device of the applications server computer system 108 which controls access to and from the database 200. It should be understood that the scope of the present invention includes systems 100 having multiple databases 200 residing on one or more data storage devices and having a split database 200 residing on one or more data storage devices.

The computer software application programs, during operation, retrieve, store, and update appropriate data stored in the database 200 as depicted by data communication paths 210. Once data is stored in the database 200 by a consumer, restaurant manager, or third-party user, the data is almost instantly accessible to certain other consumers, restaurant managers, third-party users, and/or system administrators. Thus, for instance, when a consumer elects to process (i.e., place) an order for a menu item via the consumer application 202 as described below, the restaurant identified in the order will almost instantaneously be able to review the order information via the restaurant application 204 and the restaurant's computer system.

The computer software application programs, via data communication paths 212, also bi-directionally communicate data, during operation, with an operating system 214 of the applications server computer system 108 and utilize various operating system capabilities and features, as necessary, to accomplish respective tasks. Operating together, but with respect to their appropriate users, the computer software application programs of the system 100 comprise an overall system method 300 for recommending restaurants and taking orders of menu items.

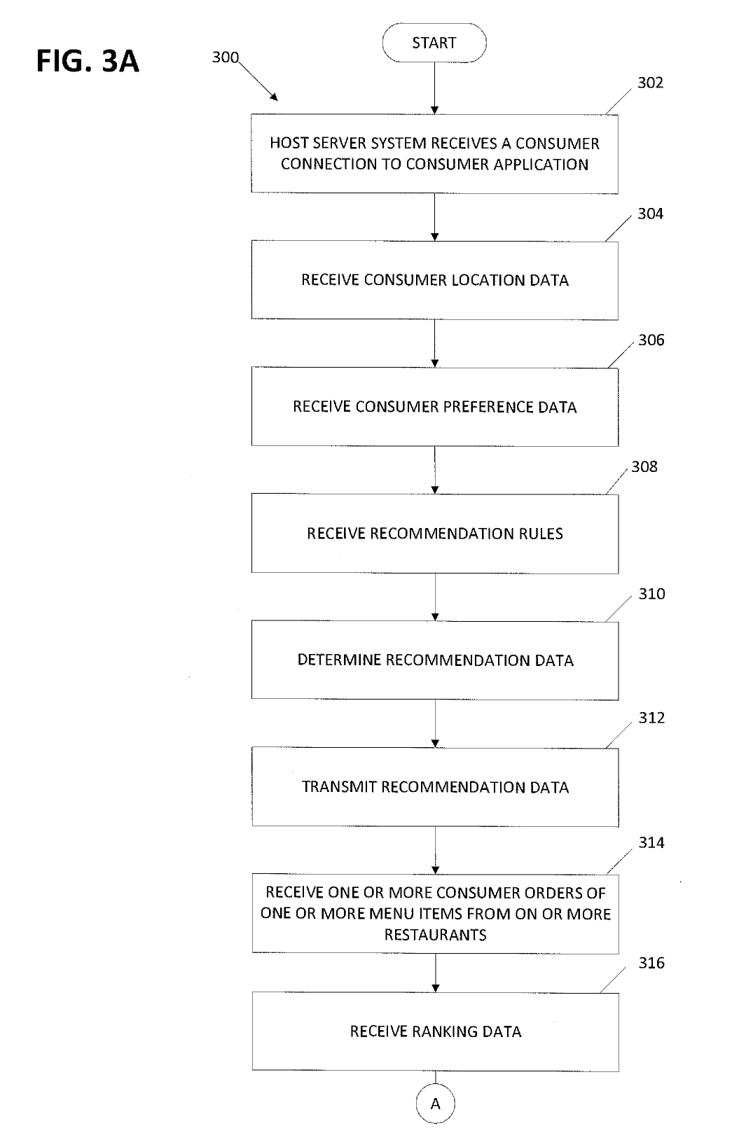

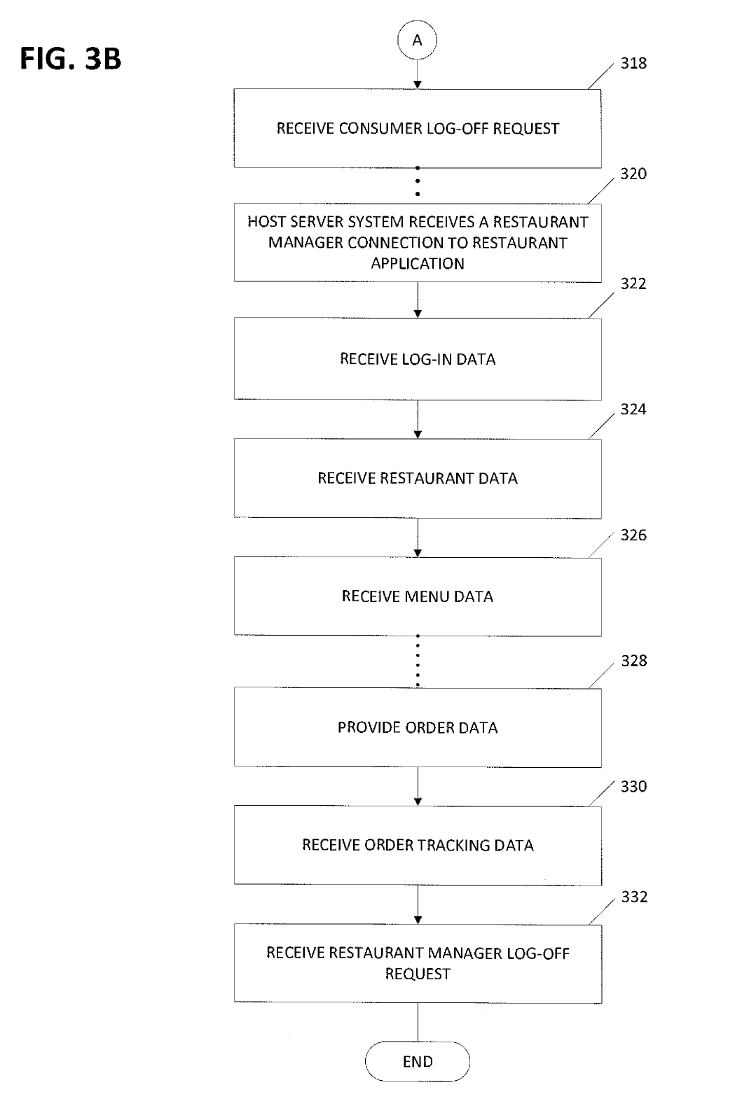

FIGS. 3A and 3B displays a flowchart representation of a method 300 in accordance with the preferred embodiment of the present invention. As seen FIGS. 3A and 3B, the method 300 comprises a plurality of steps which are, generally, executed by the applications server computer system 108 during a plurality of interactive sessions with one or more different consumers, restaurant managers, third-party users, and/or system administrators. Each interactive session comprises a period of time during which a computer system 114, 116, 118, 120 of a respective consumer, restaurant manage, third-party user, or system administrator is communicatively connected to the host server system 106 and exchanges data with the host server system 106 through execution of the Internet browser software of computer systems 114, 116, 118, 120 and under the control of the appropriate consumer, restaurant, third-party, or administrator applications 202, 204, 206, 208 executing continually on the applications server computer system 108.

Typically, during an interactive session, a consumer, restaurant manager, third-party user, and/or administrator performs one or more tasks associated with the recommendation of multiple entity restaurants and menu items, and the taking orders of menu items, which are enabled by the system 100. Further, a particular consumer, restaurant manager, third-party user, and/or system administrator may conduct multiple sessions on a given day. It should be noted that during a particular session, a consumer, restaurant manager, third-party user, and/or administrator may desire to perform certain tasks and not others, leaving remaining tasks to be performed during a subsequent session (although such subsequent sessions are not shown in FIGS. 3A and 3B). It should also be noted that the system 100 is operable to allow numerous different consumers, restaurant managers, third-party users, and system administrators to manage their inputs and, hence, is operable to conduct pluralities of sessions with numerous different consumers in a substantially simultaneous manner or at various different times. Further, it should be noted that while FIGS. 3A and 3B is intended to display a general plurality of steps which are, substantially, representative of an overall method 300 of the present invention, many other steps may be performed by consumers, restaurant manager, third-party users, and system administrators during interactive sessions which are not shown in FIGS. 3A and 3B for purposes of clarity, but which may be described herein.

Generally, during an interactive session, the appropriate consumer, restaurant, third-party user, and administrator manager application 202, 204, 206, 208 communicates appropriate web page data representative of web pages (i.e., appropriate for the status as a consumer, restaurant manager, third-party user, or system administrator) and data associated in context with the web pages (i.e., retrieved from database 200) to the consumer, restaurant manager, third-party user, or system administrator systems 114, 116, 118, 120. Upon the receipt thereof, the consumer, restaurant manager, third-party user, or system administrator systems 114, 116, 118, 120 display the web pages and associated system data using their Internet browser software or other network communications software, thereby enabling the system 100 to “present” appropriate information or data to the respective consumer, restaurant manager, third-party user, or system administrator. The consumers, restaurant managers, third-party users, and system administrators interact with the system 100, during a session, by providing input information to their respective computer systems 114, 116, 118, 120. After receiving the input information, the computer systems 114, 116, 118, 120 communicate the input information, via their Internet browsers, to the appropriate consumer, restaurant manager, third-party user, and administrator application 202, 204, 206, 208 for the session.

When one or more consumers wish to interact with the system 100, the host server system 106 and consumer application 202 establish an interactive session with the one or more consumers, at step 300, in response to the respective consumer's computer system 114 being pointed to the Internet web site address for the consumer application 202 by the consumer. (FIGS. 3A and 3B) The applications server 108 then presents a home web page of the consumer application 202 to the consumer. At step 302, the host server system 106 receives and confirms a valid user name and password for the consumer. It is noted that the steps shown in FIGS. 3A and 3B can be performed in any order or omitted in its entirety.

During use of the system 100 by the consumer, the consumer application 202 receives consumer location data at step 304. The consumer location data is determined using a variety of different methods and technologies, many of which are known to a person of ordinary skill in the art and will not be explained in detail. Consumer location data may be in the form of a GPS (global positioning system) signal containing location information specific to a dedicated device, or other means for location determination. In at least one embodiment, the consumer application 202 receives a set of data identifying the location of a consumer's device, such as GPS coordinates or any other GPS-related location information and stores it as the consumer location data in the database 200. In another embodiment, the consumer application 202 receives a set of data identifying the particular location of a dedicated device and stores it as consumer location data in the database 200. In yet another embodiment, the consumer application 202 receives consumer location data identifying consumer's location by, including without limitation to a ZIP code, a street address, or a city and state that the consumer manually inputs, and stores it in database 200.

At step 306, the consumer application 202 receives consumer preference data. The consumer preference data may include one or more of the following: consumer ingredient preferences, consumer cuisine preferences, consumer menu item preferences, consumer nutritional preferences, consumer spending preferences, consumer dining preferences, and consumer restaurant preferences. The consumer application 202 maintains consumer preference data by adding, deleting, and/or updating the database 200 in accordance with the consumer's one or more preference submissions to the consumer application 202, and thus provides a historical record of consumer preference data. It should be understood that the above-list of consumer preference data is not inclusive and, hence, the consumer preference data includes additional information not presented in the list.

During the consumer's interactive session, the consumer application 202 may receive one or more recommendation rules from the database 200 at step 308. The consumer application 202 allows the consumer to choose which recommendation rules to be applied to the consumer preference data and/or the consumer location data, or the consumer application 202 may apply a default recommendation rules. At step 310, the host server system 106 determines recommendation data based on the recommendation rules, the consumer location data, the consumer preference data, the restaurant data, and/or the menu data. Then, at step 312, the recommendation data is transmitted to the consumer.

During the consumer's interactive session, the consumer application 202 may receive one or more orders of one or more menu items from one or more restaurants from the consumer at step 314. The consumer application 202 maintains consumer orders in the consumer preference data by adding, deleting, and/or updating the database 200 in accordance with the consumer's one or more order submissions to the consumer application 202, and thus provides a historical record of consumer orders as consumer preference data. The customer preference data may also include past orders, past searches, past merchant and restaurants, past ingredient data, past menu or items ordered, past cuisines ordered, and past nutritional data ordered.

In addition, when a consumer uses the consumer application 202 to submit an order through the system 100, the host server system 106 and the consumer application 202 may process the consumer preference data contained in the database 200 to generate additional consumer preference data inquiries, which are then used to refresh the content of customer preference data. The consumer application 202 may receive scoring, ranking, and recommendations corresponding to restaurants, menu items, orders, quality, and the like from the consumer as ranking data at step 316.

As indicated by step 318, the consumer application 202 may receive a log-off request from the consumer, and thus, ends the interactive session with the consumer.

As shown in FIGS. 3A and 3B, concurrently or after a passage of time, when one or more restaurant managers wish to interact with the system 100, the host server system 106 and restaurant application 204 establish an interactive session with the one or more restaurant managers at step 320, in response to the respective restaurant manager's computer system 116 being pointed to the Internet web site address for the restaurant application 204 by the restaurant manager. The applications server 108 then presents a home web page of the restaurant application 204 to the restaurant manager. At step 322, the host server system 106 receives and confirms a valid user name and password, log-in data, from the restaurant manager. It is noted that the steps shown in FIGS. 3A and 3B can be performed in any order or be omitted in its entirety.

During use of the system 100 by the restaurant manager, the restaurant application 204 receives restaurant data, also known as business data, at step 324. The restaurant data may include one or more of the following: a location of a restaurant (such as mobile locations of restaurants as food trucks), operating hours of the restaurant, restaurant cuisine types information, restaurant ingredient information, restaurant wait time information, restaurant cost information, restaurant offer and discount information, and restaurant order taking availability information. The restaurant application 204 maintains restaurant data by adding, deleting, and/or updating the database 200 in accordance with the restaurant manager's one or more business data submissions to the restaurant application 202, and thus provides an up-to-date business record of business data. It should be understood that the above-list of business data is not inclusive and, hence, the business data includes additional information not presented in the list.

At step 326, during a restaurant manager's interactive session, the restaurant application 204 may receive menu data. The menu data may include one or more of the following: current menu items, current menu items ingredients information, and nutrition information about menu items. The restaurant application 204 maintains menu data by adding, deleting, and/or updating the database 200 in accordance with the restaurant manager's one or more menu data submissions to the restaurant application 202, and thus provides an up-to-date record of menu data. It should be understood that the above-list of menu data is not inclusive and, hence, the menu data includes additional information not presented in the list.

During the restaurant manager's interactive session, the restaurant application 204 provides the restaurant manager with order data received from one or more consumers at step 328. The order data corresponds to the one or more orders of one or more menu items for the restaurant received from the consumer at step 314.

At step 330, during a restaurant manager's interactive session, the restaurant application 204 may receive order tracking data. Tracking data is used to provide status updates about fulfillment of orders, including but not limited to acknowledgement of orders, processing of orders, delivery of orders, and/or completing orders. The restaurant application 204 maintains tracking data by adding, deleting, and/or updating the database 200 in accordance with the restaurant manager's one or more tracking data submissions to the restaurant application 204, and thus provides an up-to-date record of order fulfillment.

As indicated by step 332, the restaurant application 204 may receive a log-off request from the restaurant manager, and thus, ends the interactive session with the restaurant manager.

The consumer application 202, as shown in FIG. 2, comprises a plurality of software modules, or procedures, having associated methods, when executed by the applications server 108, enable a consumer to perform a number of tasks associated with: the generation, editing, submission, and monitoring of location data, preferences, and/or orders. Such software modules include, preferably, a consumer location module 220, a consumer preference module 230, a recommendation module 240, an order module 250, and a tracking module 260. The various software modules are accessible to and selectable by a consumer upon establishing a session with the consumer application 202. Once selected by a consumer, the respective methods of the modules are executed by the applications server 108.

The consumer location module 220 allows the consumer to select the method in which a consumer's location is determined. As noted above, consumer location data is determined using a variety of different methods and technologies, many of which are known to a person of ordinary skill in the art and will not be explained in detail. When setting a location, the consumer location module 220 presents various methods of determining a consumer's location. The consumer may select from using GPS coordinates or any other GPS-related location information of the consumer's system 114, a preset location that is set in the database 200 of the host server system 106, or by entering address information, including but not limited to a ZIP code, a street address, or a city and state.

The consumer preference module 230 enables a consumer to input his or her ingredient preferences (which may be according to dietary needs or restrictions, such as vegetarian, vegan, lactose intolerance, gluten intolerance, etc.), cuisine preferences (such as Italian, Sushi, Mexican, BBQ, etc.), menu item preferences (such as particular entrees, soups, salads, etc.), consumer nutritional preferences (such as calorie limits, fat limits, cholesterol limits, etc.), consumer spending preferences (such as a maximum or minimal cost), consumer dining preferences (such as take-out, delivery, dine-in), consumer restaurant preferences (such as favorite restaurants), and any other consumer preference data, as needed. Further, the consumer preference module 230 allows the existing consumer preference data in the database 200 to be reviewed, added to, deleted from, and/or updated. The consumer preference module 230 may also provide the consumer with historical consumer preference data, which may include past orders from restaurants, including but not limited to comments/notes on the order, ratings of the order, rating of the menu item, etc. Such historical consumer preference data may also be added to, deleted from, and/or updated.

The recommendation module 240 allows a consumer to determine what recommendation rules, which are stored in the database 200, will be used to help a consumer choose a restaurant and/or menu item. In other words, the recommendation module 240 is used to search, browse and sort, and filter recommendations based on the above-mention consumer preferences. The recommendation module 240 is capable of receiving the consumer location data and consumer preference data and receiving the up-to-date restaurant data and current menu data to determine recommendation data, which is a customized ranking of restaurants and menu items.

Preset functions are also provided by the recommendation module 240. For example, a consumer may be presented with the ability to select an option such as “Be Good/Be Healthy/Be Cheap” or “Be Bad/Be Unhealthy/Be Expensive,” which presents recommendation data for good/healthy/cheap restaurants and/or menu items or bad/unhealthy/expensive restaurant and/or menu items, respectively. The presented recommendation data may provide the nutritional information of the one or more recommended menu items, and provide a total of all the nutritional information of more than one menu items.

Another function provided by the recommendation module 240 is the pathing function, where the recommendation module 240 uses both current consumer location data and historical consumer location data for enhancing customer recommendations. For example, the recommendation module 240 may compare the current location of the consumer with the consumer preference data (in particular, the consumer's past orders, historical menu items, and historical restaurant choices), and provide currently available restaurants and/or menu items that are located nearby the consumer. Further, historical consumer location data may be used to provide recommendation data based on regularly visited locations or traveled routes. This pathing function may be presented by selecting an option, such as “on the way home”, “near the office”, “picking up the kids,” or the like.

Further, the recommendation module 240 may provide recommendations on more complex associations (e.g., “consumers who search for X tend to order Y,” or “consumers who order A and B tend to order C.”). For example, if a consumer selects particular menu choices a predetermined number of times, the system recognizes this pattern, and stores this as part of the consumer preference data. Additionally, the recommendation module 240 is also capable of recognizing many consumer selection and preference patterns and storing that information as recommendation rules.

The order module 250 allows a consumer to place one or more orders, and/or to manage one or more existing orders. When the consumer submits and order with the order module 250, the order module 250 updates the database 200 and provides the order data to the order module 290 of the restaurant application 204. The order data may include one or more of the following: one or more menu items, delivery location, pick-up information, consumer or third-party identification information, payment information, special order needs, discount and/or financial incentives applied, etc.

The tracking module 260 allows a consumer to review tracking data provided by the restaurant application 204. Tracking data is used to provide status updates about fulfillment of orders, including but not limited to acknowledgement of orders, processing of orders, delivery of orders, and/or completing orders. The restaurant application 204 maintains tracking data by adding, deleting, and/or updating the database 200 in accordance with the restaurant manager's one or more tracking data submissions to the restaurant application 204, and thus provides an up-to-date record of order fulfillment.

The restaurant application 204, as shown in FIG. 2, comprises a plurality of software modules, or procedures, having associated methods, when executed by the applications server 108, enable a restaurant manager to perform a number of tasks associated with: the generation, editing, submission, and monitoring of business data, menu data, and/or order data. Such software modules include, preferably, a business module 270, a menu module 280, and an order module 290. The various software modules are accessible to and selectable by a restaurant manager upon establishing a session with the restaurant application 204. Once selected by a restaurant manager, the respective methods of the modules are executed by the applications server 108.

The business module 270 enables a restaurant manager to input the restaurant's location (including fixed location and/or mobile locations, such as food trucks), operating hours (which can be different at each location), restaurant cuisine types information (such as Italian, Sushi, Mexican, BBQ, etc.), restaurant ingredient information (which may include dietary needs or restrictions, such as vegetarian, vegan, lactose intolerance, gluten intolerance, etc.), restaurant wait time information, restaurant cost information, restaurant offer and discount information, and restaurant order taking availability information (which may be used to allow the taking of orders, control/restrict the amount or orders, or prevent orders), and any other restaurant data, as needed. Further, the business module 270 allows the existing business data in the database 200 to be reviewed, added to, deleted from, and/or updated. The business module 270 may also provide the restaurant manager with historical business data, which may include past orders from restaurants, including but not limited to comments/notes on an order, ratings of an order, rating of a menu item, etc. Such historical business data may also be added to, deleted from, and/or updated. Once a restaurant manager submits the input in the business module 270, the database 200 of the host server system 106 is updated, which in turn such updated business data is reflected in the consumer application 202, third-party application 206, and administrator application 208.

The menu module 280 enables a restaurant manager to input one or more menu items, pricing information for the menu items, a category of the menu item, pricing for the menu item, ingredients for the menu item, and any other menu item information, as needed. Further, the menu module 280 allows the existing menu data in the database 200 to be reviewed, added to, deleted from, and/or updated. The menu module 280 may also provide the restaurant manager with historical menu data, which may include past orders for a particular menu item, past costs of the menu item, comments/notes on the menu item, ratings of the menu item, etc. Such historical menu data may also be added to, deleted from, and/or updated. Once a restaurant manager submits the input in the menu module 280, the database 200 of the host server system 106 is updated, which in turn such updated menu data is reflected in the consumer application 202, third-party application 206, and administrator application 208.

The order module 290 allows a restaurant manager to manage orders from multiple consumers and/or third-party users. When an order comes in from a consumer or a third-party user, the order module 290 provides order data to the restaurant manager. The order data may include one or more of the following: one or more menu items, delivery location, pick-up information, consumer or third-party identification information, payment information, special order needs, etc.

Once a restaurant manager has received the order data in the order module 290, the database 200 of the host server system 106 is updated, which in turn such updated order data is reflected in the consumer application 202, third-party application 206, and administrator application 208. The restaurant manager, through the order module 290, may submit periodic updates to order statuses, which may be disseminated through the host server system 106.

As shown in FIGS. 1 and 2, a third-party user may use the third-party user application 206 to establish an interactive session with the third-party user system 118 being pointed to the Internet web site address for the third-party user application 206. A third-party user system 118 may include a restaurant's own application, website, internal point-of-sale platform, and/or third-party centralized ordering platforms. The third-party user application 206 may be used to communicate with both stand-alone point-of-sale and integrated point-of-sale platforms. The third-party user application 206 allows a restaurant to maintain their legacy custom internal point-of-sale systems for ensuring accurate order processing and invoicing. Further, restaurants may adopt a point-of-sale system that is specifically designed to process the various types of information collected by the overall system.

The third-party user application 206 may also be used as a “corporate dashboard” that allows one or more corporations, health care companies, and/or other entities to provide financial incentives and/or discounts to consumers. Such financial incentive or discounts could be applied to a consumer for choosing to purchase one or more healthy items from the menu. The third-party user application 206 allows employers and insurance companies to choose flexible criteria, such as a calorie count, to give the real time financial incentive and/or discount. The consumer application 202 may provide the consumer with a list of qualified financial incentives and/or discounts based on the information provided to the third-party user application 206. Further, the third-user application 206 may provide a corporation and/or employer with the ability to track all corporate purchases, and provide an automated volume discount to orders from participating restaurants.

As also shown in FIGS. 1 and 2, an administrator may use the administrator application 208 to establish an interactive session with the administrator system 120 being pointed to the Internet web site address for the administrator application 208. The administrator application 208 may receive and confirm a valid user name and password for the system administrator. The applications server 108 then presents a home web page of the administrator application 208 to the system administrator. The applications server 108 may then receive configuration data from the system administrator for consumers, restaurant managers, and third-party users, appropriately associate the configuration data, and store the configuration data in appropriate data tables of database 200. Configuration data may include user names and passwords, which are used to control access to the system 100. It should be understood that the above-list of configuration data is not inclusive and, hence, the configuration data includes additional information not presented in the list.

The invention has been described above in detail with references to a preferred embodiment. It is understood that variations and modifications can be effected within the spirit and scope of the invention.

What is claimed is:

1. A method for managing multiple entity food vendor recommendation and ordering services, the method comprising:
receiving consumer location data, consumer preference data, restaurant data, and menu data from a communication network;
receiving recommendation rules from a database;
determining recommendation data based on the recommendation rules, the consumer location data, the consumer preference data, the restaurant data, and the menu data; and
transmitting the recommendation data to the communication network.

2. The method according to claim 1, further comprising:
receiving historical consumer preference data from the database; and
determining the recommendation data based on the historical consumer preference data, the consumer location data, the consumer preference data, the restaurant data, and the menu data.

3. The method according to claim 2, further comprising:
updating the historical consumer preference data in the database with the consumer preference data; and
storing the updated historical consumer preference data in the database as historical consumer preference data.

4. The method according to claim 1, wherein the consumer preference data includes information relating to at least one of consumer ingredient preferences, consumer cuisine preferences, consumer menu item preferences, consumer nutritional preferences, consumer spending preferences, consumer dining preferences, and consumer restaurant preferences.

5. The method according to claim 1, wherein the restaurant data includes information relating to at least one of a location of a restaurant, operating hours of the restaurant, restaurant cuisine types information, restaurant ingredient information, restaurant wait time information, restaurant cost information, restaurant offer and discount information, and restaurant order taking availability information.

6. The method according to claim 1, wherein the menu data includes information relating to at least one of current menu items, current menu items ingredients information, and nutrition information about menu items.

7. The method according to claim 1, further comprising:
receiving consumer order data from the communication network; and
providing the consumer order data to a restaurant through the communication network.

8. The method according to claim 2, further comprising:
receiving consumer order data from the communication network; and
providing the consumer order data to a restaurant through the communication network.

9. The method according to claim 8, further comprising:
updating the historical consumer preference data in the database with the consumer preference data and the consumer order data; and
storing the updated historical consumer preference data in the database as historical consumer preference data.

10. The method according to claim 1, further comprising:
receiving historical consumer location data from the database; and
determining the recommendation data based on the historical consumer location data, the consumer location data, the consumer preference data, the restaurant data, and the menu data.

11. A system for managing multiple entity food vendor recommendation and ordering services comprising:
a host server operable for data communication via a communication network,
wherein the host server is configured to receive from the communication network input data related to a consumer location, input data related to consumer preferences, input data related to at least one restaurant, and input data related to menu information for the at least one restaurant,
wherein the host server is configured, based on at least in part upon the input data applied to at least one recommendation rule, to determine a recommendation of at least one of a restaurant and a menu item, and
wherein the host server is configured to transmit the recommendation to the communication network.

12. The system according to claim 11,
wherein the host server is configured to receive historical consumer preference data from the database; and
wherein the host server is configured to determine the recommendation data based on the historical consumer preference data, the consumer location data, the consumer preference data, the restaurant data, and the menu data.

13. The system according to claim 12,
wherein the host server is configured to update the historical consumer preference data in the database with the consumer preference data; and
wherein the host server is configured to store the updated historical consumer preference data in the database as historical consumer preference data.

14. The system according to claim 11, wherein the consumer preference data includes information relating to at least one of consumer ingredient preferences, consumer cuisine preferences, consumer menu item preferences, consumer nutritional preferences, consumer spending preferences, consumer dining preferences, and consumer restaurant preferences.

15. The system according to claim 11, wherein the restaurant data includes information relating to at least one of a location of a restaurant, operating hours of the restaurant, restaurant cuisine types information, restaurant ingredient information, restaurant wait time information, restaurant cost information, restaurant offer and discount information, and restaurant order taking availability information.

16. The system according to claim 11, wherein the menu data includes information relating to at least one of current menu items, current menu items ingredients information, and nutrition information about menu items.

17. The system according to claim 11,
wherein the host server is configured to receive consumer order data from the communication network; and
wherein the host server is configured to provide the consumer order data to a restaurant through the communication network.

18. The system according to claim 12,
wherein the host server is configured to receive consumer order data from the communication network; and
wherein the host server is configured to provide the consumer order data to a restaurant through the communication network.

19. The system according to claim 18,
wherein the host server is configured to update the historical consumer preference data in the database with the consumer preference data and the consumer order data; and
wherein the host server is configured to store the updated historical consumer preference data in the database as historical consumer preference data.

20. The system according to claim 11,
wherein the host server is configured to receive historical consumer location data from the database; and
wherein the host server is configured to determine the recommendation data based on the historical consumer location data, the consumer location data, the consumer preference data, the restaurant data, and the menu data.
